(19) United States
(12) Patent Application Publication
(10) Pub. No.: US 2025/0314827 A1
(43) Pub. Date: Oct. 9, 2025

(54) Mode-Field Optical Converter

(71) Applicant: Nippon Telegraph and Telephone Corporation, Tokyo (JP)

(72) Inventors: Shiori Konisho, Musashino-shi, Tokyo (JP); Junji Sakamoto, Musashino-shi, Tokyo (JP); Toshikazu Hashimoto, Musashino-shi, Tokyo (JP)

(21) Appl. No.: 18/866,367

(22) PCT Filed: May 17, 2022
(86) PCT No.: PCT/JP2022/020570

§ 371 Date: Nov. 15, 2024

(51) Int. Cl. G02B 6/14; G02B 6/122

(52) U.S. Cl. CPC G02B 6/14; G02B 6/1228

(57) ABSTRACT

A loss generated when a mode field is converted is suppressed. A mode-field conversion optical circuit that converts a mode field of light propagating through an optical waveguide includes a mode-field converter that is connected to a core of the optical waveguide and converts the mode field of the light, and a reflection structure disposed at an interval along an optical axis direction of the mode-field converter.

### TECHNICAL FIELD

The present invention relates to an optical circuit that reduces a radiation loss generated when a mode field is converted in an optical waveguide.

### BACKGROUND ART

The optical waveguide includes a core having a refractive index difference and a cladding formed on a substrate, and light propagates through the core formed in a desired pattern. By adiabatically changing a width, a height, or the like of the core, the mode field of the propagating light can be converted. For example, at an input/output end of an optical circuit formed on a substrate, a spot size converter (SSC) for matching a mode field of an optical waveguide and a mode field of an optical fiber is provided. By bringing the mode fields of the optical waveguide and the optical fiber close to each other, a connection loss between the optical waveguide and the optical fiber can be reduced. It has been reported that by installing the SSC, a coupling rate is improved as compared with a case where an optical fiber and a waveguide not provided with the SSC are connected (see, for example, Non Patent Literature 1).

In addition, there is known a mode filter that adiabatically converts the width and height of the core, narrows the optical waveguide, and cuts off a higher-order mode.

In the SSC and the mode filter, when the mode field is converted, a field size is converted without loss by adiabatically changing the width, height, and the like of the core. However, due to demands for miniaturization of optical circuits, adiabatic conversion cannot be performed due to limits of the field size that can be converted, and there is a problem that a loss occurs.

### CITATION LIST

### Non Patent Literature

Non Patent Literature 1: M. Itoh, et al., “LOW-LOSS 1.5% Δ ARRAYED WAVEGUIDE GRATING WITH SPOT-SIZE CONVERTERS,” Proc. 27th Eur. Conf. on Opt. Comm., Mo.F.2.4, pp. 8-9, 2001.

### SUMMARY OF INVENTION

An object of the present invention is to provide a mode-field conversion optical circuit capable of suppressing a loss generated when a mode field is converted.

In order to achieve such an object, an embodiment of the present invention is a mode-field conversion optical circuit that converts a mode field of light propagating through an optical waveguide, the mode-field conversion optical circuit including a mode-field converter that is connected to a core of the optical waveguide and converts the mode field of the light, and a reflection structure disposed at an interval along an optical axis direction of the mode-field converter.

### BRIEF DESCRIPTION OF DRAWINGS

FIG. 1 is a diagram illustrating a mode-field conversion optical circuit according to a first embodiment of the present invention.

FIG. 2 is a diagram illustrating a coupling rate with an optical fiber in a case where the mode-field conversion optical circuit of the first embodiment is applied.

FIG. 3 is a diagram illustrating a mode filter according to a second embodiment of the present invention.

FIG. 4 is a diagram illustrating a tapered waveguide according to a third embodiment of the present invention.

### DESCRIPTION OF EMBODIMENTS

A detailed description of embodiments of the present invention will be described below with reference to the drawings. In the present embodiment, an example in which a planar lightwave circuit (PLC) is used as a mode-field conversion optical circuit will be described. A silica-based PLC is a waveguide device having low loss and high reliability, and is widely used as a platform for achieving an integrated circuit such as an optical multiplexer/demultiplexer, an optical switch, and an optical splitter as an optical device for communication.

Note that the material of the mode-field conversion optical circuit of the present invention is not particularly limited, and other material waveguides such as a silicon (Si) waveguide, an indium phosphide (InP) waveguide, and a polymer waveguide can be applied without being limited to the quartz-based waveguide.

### First Embodiment

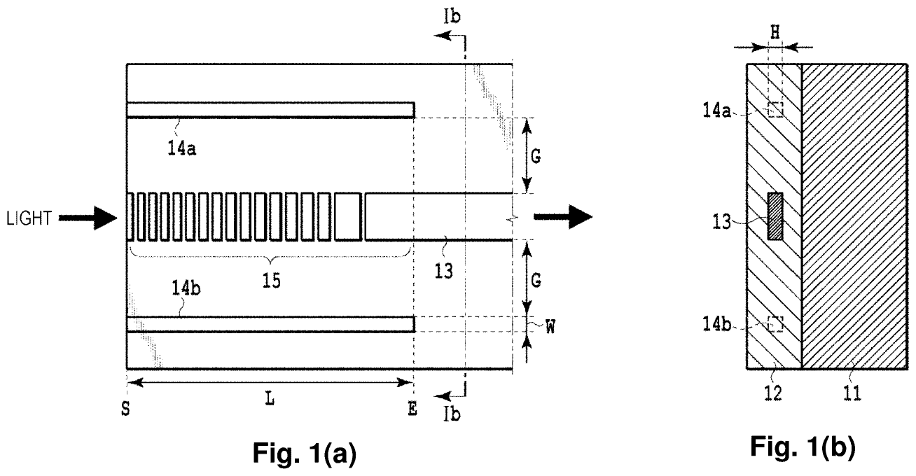

FIG. 1 illustrates a mode-field conversion optical circuit according to a first embodiment of the present invention. FIG. 1(a) is a perspective view of a PLC 10 as viewed from above, and FIG. 1(b) is a diagram illustrating a cross section perpendicular to an optical axis of a waveguide. This example is applied to a spot size converter (SSC) for matching a mode field of an optical waveguide of the PLC 10 with a mode field of an optical fiber. The optical waveguide of the PLC 10 is provided with a segment waveguide type SSC 15 connected to a core 13 at a connection end with the optical fiber. Further, in the PLC 10, reflection structures 14a and 14b having the same shape as a straight waveguide are installed at intervals on both sides along an optical axis direction of the SSC 15. The SSC 15 is not limited to the segment waveguide type, and a structure for converting a mode field of light can be applied. For example, other mode-field converters can be used, such as a structure having a tapered core.

A purpose of installing the reflection structures 14a and 14b is to reflect light radiated from a side surface of the SSC 15 and to recouple the reflected light to the waveguide. As will be described later, the reflection structures 14a and 14b are regions made of the same material as the core 13 and having a refractive index higher than that of a cladding 12. Therefore, a boundary surface between the reflection structures 14a and 14b and the cladding 12 acts as a reflection surface. First, a boundary surface on the SSC 15 side in the reflection structures 14a and 14b is set as a reflection surface, and intervals G between the reflection structures 14a and 14b and the SSC 15 are set according to the wavelength of signal light propagating through the core 13 and a mode field of an optical fiber to be connected. Next, a boundary surface on the side opposite to the SSC 15 side is set as a reflection surface, and widths W of the reflection structures 14a and 14b are set in the same manner. When the reflection structures do not have a linear shape, it may be set for each minute section in a longitudinal direction of the reflection structures. In any case, the intervals G and the widths W may be obtained using a wavefront matching method.

Lengths L of the reflection structures 14a and 14b are equal to a length of the SSC 15, that is, start point S/end point E of the reflection structures 14a and 14b is matched with start point S/end point E of the SSC 15. This is because light is radiated from the start point to the end point of the SSC 15. Note that, strictly speaking, radiation from the SSC 15 is radiated not only in a component perpendicular to the optical axis but also in a spread manner. Therefore, if there is a margin in the space on the PLC 10, the reflection structures 14a and 14b are desirably longer than the end point E and longer than the length of the SSC 15.

Since the light radiation is symmetric with respect to the light traveling direction, the reflection structures 14a and 14b are provided symmetrically, that is, at equal intervals (intervals G) on both sides with the SSC 15 as the center. In FIG. 1, one reflection structure is provided on each side, but a plurality of reflection structures may be provided. Since the number of reflection surfaces increases, the reflectance can be increased. On the other hand, although the effect of reducing the radiation loss is halved, the reflection structure may be provided only on one side. When a plurality of reflection structures is provided, the number of reflection structures installed on both sides may be different. In addition, the reflection structures 14a and 14b are not necessarily limited to straight waveguides, and a structure having a shape corresponding to the radiation direction of light from the mode-field converter can be employed as a structure corresponding to the shape of the mode-field converter.

By providing such reflection structures 14a and 14b, it is possible to reduce the radiation loss by reflecting the light radiated from the SSC 15 and recombining the light with the SSC 15.

For the production of the mode-field conversion optical circuit, a well-known method for producing a PLC can be applied, and a brief description will be given here. On a Si substrate 11, an undercladding layer made of silica-based glass (SiO₂) and a core layer made of silica-based glass having a refractive index increased by doping germanium (Ge) are sequentially deposited. The core layer is processed by common photolithography and dry etching techniques to form the core 13 of the optical waveguide in a desired pattern.

At the same time, linear waveguides of desired patterns to be the reflection structures 14a and 14b are also formed. Thereafter, an overcladding layer made of silica-based glass is deposited on the core 13 to form an embedded waveguide including the core 13 and the cladding 12.

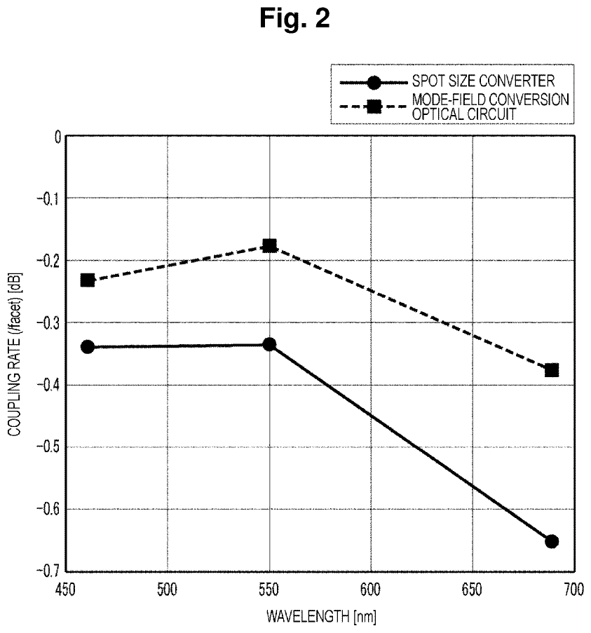

FIG. 2 illustrates a coupling rate with an optical fiber in a case where the mode-field conversion optical circuit of the first embodiment is applied. This is a result of simulation of the coupling rate when the optical waveguide of the PLC and the optical fiber are butt-connected at a connection end surface. The optical fiber to be used is assumed to be a single mode optical fiber (S405-XP), and the wavelength to be used is assumed to be 450 to 700 nm. A commercially available optical fiber may have a different mode field for each production slot, but this time, the mode field of a purchased optical fiber was measured, and the measured value was used as a target mode field.

In the mode-field conversion optical circuit (two reflection structures including the segment waveguide type SSC+linear waveguide) illustrated in FIG. 1, a width of the core 13 of the PLC 10=2.3 μm, the widths W of the reflection structures 14a and 14b=1.1 μm, the length L=600 μm, and the interval G between the reflection structures 14a and 14b and the SSC 15=6.0 μm are set.

The mode-field conversion optical circuit of the present embodiment and a case of the segment waveguide type SSC only for comparison were simulated. A horizontal axis indicates a wavelength, a vertical axis indicates a coupling rate, the case of the segment waveguide type SSC only is indicated by a solid line, and the mode-field conversion optical circuit of the present embodiment is indicated by a broken line. By the mode-field conversion optical circuit, the coupling rate between the optical fiber and the optical waveguide is improved in the entire wavelength band of interest. On the longer wavelength side where light is easily radiated, the coupling rate is greatly improved, and the wavelength difference of the coupling rate is also reduced.

As described above, it has been confirmed that the loss generated in the existing mode-field converter can be suppressed by the mode-field conversion optical circuit of the present embodiment.

### Second Embodiment

In the first embodiment, the SSC installed on the connection end surface with the optical fiber is taken as an example, but in a second embodiment, an application example to a mode filter installed in an optical circuit as a mode-field converter will be described. For example, in the segment waveguide, light of a 0th-order mode is easily propagated but light is less easily propagated as the order becomes higher, and thus the segment waveguide operates as a mode filter. At this time, in order to enhance the filtering effect for suppressing higher-order modes, it is necessary to reduce the ratio of the core to the pitch of the segment, which is the fill factor of the segment. However, if the fill factor is small, the radiation loss of the 0th-order mode also increases.

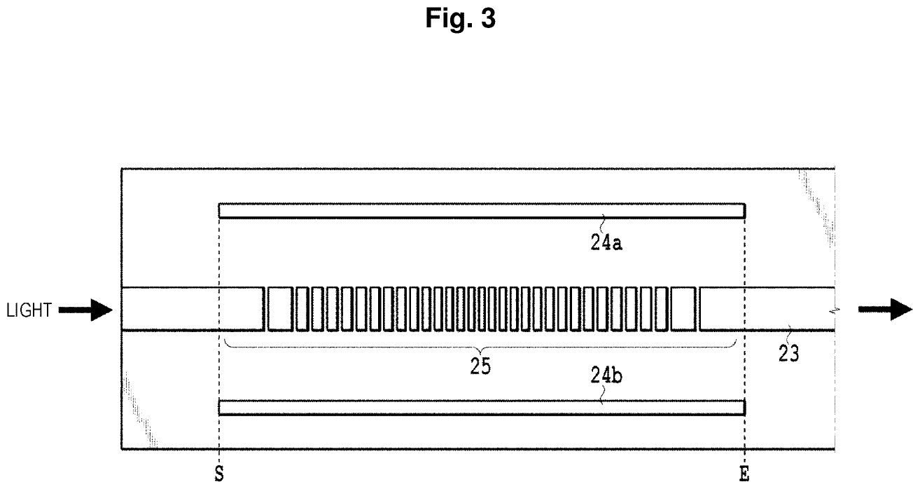

FIG. 3 illustrates a mode filter according to the second embodiment of the present invention. A segment waveguide type mode filter 25 installed in an optical circuit of a PLC 20 and connected to a core 23 is illustrated. As in the first embodiment, the PLC 20 includes reflection structures 24a and 24b having the same shape as the straight waveguide on both sides along an optical axis direction of the mode filter 25. Start point S/end point E of the reflection structures 24a and 24b is matched with start point S/end point E of the mode filter 25, and widths of the reflection structures 24a and 24b and intervals between the reflection structures 24a and 24b and the mode filter 25 are set according to the wavelength of signal light propagating through the core 23. Note that, if there is a margin in the space on the PLC 20, lengths of the reflection structures 24a and 24b are desirably longer than the start point S/end point E and longer than a length of the mode filter 25.

A configuration method and a production method of the reflection structures 24a and 24b are the same as those in the first embodiment. By providing such reflection structures 24a and 24b, it is possible to reduce the radiation loss by reflecting the light radiated from the mode filter 25 and recombining the light with the mode filter 25.

### Third Embodiment

In the first and second embodiments, the segment waveguide is taken as an example, but in a third embodiment, an application example to a tapered waveguide installed in an optical circuit as a mode-field converter will be described. The tapered waveguide needs to have a sufficient length to change the waveguide width in a tapered manner so that no loss occurs. However, a sufficient length may not be obtained due to restriction of a chip size of the PLC or the like, and a loss occurs.

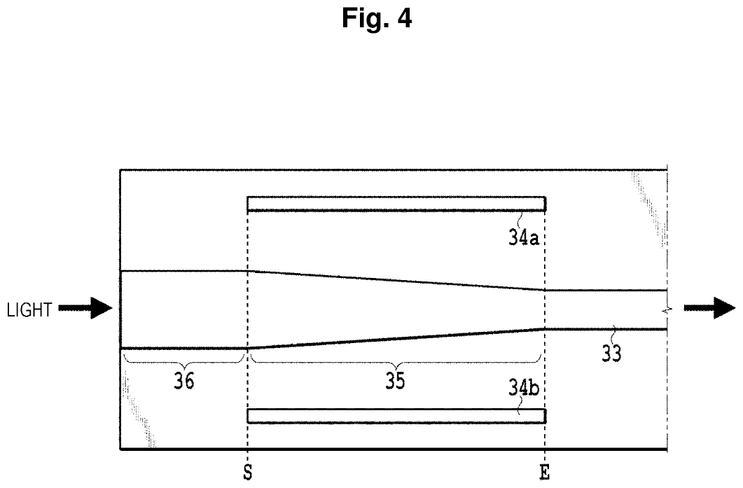

FIG. 4 illustrates a tapered waveguide according to the third embodiment of the present invention. A tapered waveguide 35 installed in an optical circuit of a PLC 30 and inserted into a core 33 is illustrated. As in the first and second embodiments, the PLC 30 includes reflection structures 34a and 34b having the same shape as the straight waveguide on both sides along an optical axis direction of the tapered waveguide 35. Start point S/end point E of the reflection structures 34a and 34b is matched with start point

S/end point E of the tapered waveguide 35, and widths of the reflection structures 34a and 34b and intervals between the reflection structures 34a and 34b and the tapered waveguide 35 are set according to the wavelength of signal light propagating through the core 33. Note that, if there is a margin in the space on the PLC 30, lengths of the reflection structures 34a and 34b are desirably longer than the start point S/end point E and longer than a length of the tapered waveguide 35.

A configuration method and a production method of the reflection structures 34a and 34b are the same as those in the first embodiment. By providing such reflection structures 34a and 34b, it is possible to reduce the radiation loss by reflecting the light radiated from the tapered waveguide 35 and recoupling the light to the tapered waveguide 35.

1. A mode-field conversion optical circuit that converts a mode field of light propagating through an optical waveguide, the mode-field conversion optical circuit comprising:
a mode-field converter that is connected to a core of the optical waveguide and converts the mode field of the light; and
a reflection structure disposed at an interval along an optical axis direction of the mode-field converter.

2. The mode-field conversion optical circuit according to claim 1, wherein the reflection structure is made of a same material as a material of the core, and has a refractive index higher than a refractive index of the cladding.

3. The mode-field conversion optical circuit according to claim 1, wherein the reflection structure includes a linear waveguide.

4. The mode-field conversion optical circuit according to claim 1, wherein the mode-field converter is a segment waveguide.

5. The mode-field conversion optical circuit according to claim 1, wherein the mode-field converter is a tapered waveguide.

6. The mode-field conversion optical circuit according to claim 1, wherein the mode-field converter is a spot size converter installed on a connection end surface with an optical fiber.

7. The mode-field conversion optical circuit according to claim 2, wherein the mode-field converter is a segment waveguide.

8. The mode-field conversion optical circuit according to claim 3, wherein the mode-field converter is a segment waveguide.

9. The mode-field conversion optical circuit according to claim 2, wherein the mode-field converter is a tapered waveguide.

10. The mode-field conversion optical circuit according to claim 3, wherein the mode-field converter is a tapered waveguide.

11. The mode-field conversion optical circuit according to claim 2, wherein the mode-field converter is a spot size converter installed on a connection end surface with an optical fiber.

12. The mode-field conversion optical circuit according to claim 3, wherein the mode-field converter is a spot size converter installed on a connection end surface with an optical fiber.
